(19) United States
(12) Patent Application Publication
(10) Pub. No.: US 2005/0207674 A1
(43) Pub. Date: Sep. 22, 2005

(54) Method, system and software for the registration of data sets

(75) Inventor: William Richard Fright, Christchurch (NZ)

Correspondence Address: NIXON & VANDERHYE, PC, 901 NORTH GLEBE ROAD, 11TH FLOOR, ARLINGTON, VA, 22203, US

(73) Assignee: APPLIED RESEARCH ASSOCIATES NEW ZEALAND LIMITED, Christchurch (NZ)

(21) Appl. No.: 11/080,656

(22) Filed: Mar. 16, 2005

(30) Foreign Application Priority Data
Mar. 16, 2004 (NZ) 531767

(51) Int. Cl. G06K 9/32; G06K 9/00

(52) U.S. Cl. 382/294; 382/154

(57) ABSTRACT

The present invention relates to a method, system and software for registration of a subject data set with a reference data set. The method of the invention includes the steps of: specifying three or more landmarks (1, 2, 3) in a first data set (8); specifying three or more corresponding landmarks (4, 5, 6) in a second data set (7); registering the first data set to the second data set using the landmarks; for at least one of the landmarks (1), determining a first patch (40) around the landmark (1) and a second patch (43) around the corresponding landmark (4); and refining the registration between the first and second data set using the patches (40, 43). A system and software for registration of a subject data set (7) with a reference data set (8) are also disclosed.

### FIELD OF INVENTION

The present invention relates to a method, system and software for registration of a subject data set with a reference data set. More particularly, but not exclusively, the present invention relates to a method, system and software for registering a subject data set with a reference data set for a 3D model.

### BACKGROUND OF THE INVENTION

Registration is defined as the process of determining a coordinate transformation on a data set in order to improve the congruence between that data set (the subject) and another (the reference).

The coordinate transformation is often required to be angle-preserving (rigid body) although may include a change of scale. At other times a non-rigid transformation (warp) may be preferred.

An example of a non-rigid transformation is the polyharmonic spline (e.g. the biharmonic, also known as the “thin-plate” spline).

Without loss of generality, the following description concerns the rigid-body registration of three dimensional surface data.

In this context, congruence may be achieved by reducing the spatial separation of the surfaces, either at defined points (“landmarks”), over the surface, or over some defined subregion(s).

In the case of landmark registration, it is usual to have explicitly defined corresponding points on both surfaces (homologous landmark pairs). At least three point pairs are required and must not be coincident or colinear. Provided these conditions are satisfied, the transformation may be determined directly (in closed-form), regardless of the initial pose of the subject with respect to the reference.

Singular value decomposition (SVD) is an example of an algorithm for direct rigid body registration of homologous landmark pairs.

The disadvantage with landmark registration is that a relatively small subset of the available data is used to determine the transformation of all points. Small errors in the specification of landmark locations can result in large mis-registration at other points on the surfaces.

In surface registration, a much larger number of the data points are used. However, the explicit point-to-point correspondence of the previous method is not available. Instead, an algorithm is required to implicitly determine the corresponding point pairs.

A commonly employed method is to simply find the closest point in the other data set. A transformation can be determined that will reduce the separation of the surfaces. This process can be repeated to iteratively converge to a condition of minimum separation.

Iterative closest point (ICP) is an example of an algorithm for iterative registration of surfaces.

However, the point-to-point correspondences produced by this kind of algorithm clearly depend at each step on the current relative pose of the subject and reference. If the initial pose is not sufficiently close to the “correct” registration, then iteration may converge to another “local” minimum.

There are several detailed descriptions of registration methods in the literature. See, particularly, An Algorithmic Overview of Surface Registration Techniques for Medical Imaging, Michel A. Audette, Frank P. Ferrie and Terry M. Peters, Medical Image Analysis (September 2000) volume 4, issue 3, pp 201-217, for a review in a medical imaging context.

It is an object of the present invention to overcome the limitations of the above methods, or to at least provide the public with a useful choice.

### SUMMARY OF THE INVENTION

According to a first aspect of the invention there is provided a method of registering a first data set with a second data set, including the steps of:
i) specifying three or more landmarks in a first data set;
ii) specifying three or more corresponding landmarks in a second data set;
iii) registering the first data set to the second data set using the landmarks;
iv) for at least one of the landmarks, determining a first patch around the landmark and a second patch around the corresponding landmark; and
v) refining the registration between the first and second data set using the patches.

It is preferred that the data sets relate to a 3D model. The data sets may relate to either a surface 3D model or a volume 3D model.

It is also preferred that the registration process in step (iii) is a direct registration method, such as singular value decomposition.

The refinement process in step (v) may include registration of surface attribute data, such as surface colour.

Preferably the landmark is approximately in the centre of the patch. The patch may be specified by the user. The patch may be a subset of the data contained within a sphere. The radius of the sphere may be specified by the user. The radius of the sphere may be related to the residual mean error resulting from the registration process in step (iii).

It is preferred that the size of all patches is equal, or approximately equal.

The patch may be specified by the user graphically. The patch may be specified by an arbitrary boundary curve. The patch may be a subset of the data contained within a projection from an arbitrary boundary curve.

Preferably the refinement process in step (v) includes matching points in the patch of the first data set with points in the patch of the second data set.

The refinement process in step (v) may include matching points in the patch of the first data set with points interpolated on the surface of the patch of the second data set.

It is preferred that a spline is used to interpolate the points. Preferably, a polyharmonic spline is used, such as a biharmonic spline.

The refinement process in step (v) may include matching points in the patch of one of the data sets with the intersection of the normal vectors of those points with the interpolated surface of the patch of the other data set.

The refinement process in step (v) may utilise an iterative registration method, such as iterative closest point.

The user may specify each landmark and corresponding landmark, or the landmarks may be specified automatically. Where the landmarks are specified automatically, it is preferred that the landmarks are specified using automatic feature recognition.

The relative position of the landmarks of the first data set may not be precisely the same as the relative position of the landmarks of the second data set.

According to a further aspect of the invention there is provided a system for registering a first data set with a second data set, including:
i) a memory for storing a first and a second data set;
ii) an input device arranged for receiving input which specifies three or more landmarks in the first data set and three or more corresponding landmarks in the second data set;
iii) a processor arranged for registering the first data set to the second data set using the landmarks, then for at least one of the landmarks, determining a first patch around the landmark and a second patch around the corresponding landmark, and then for refining the registration between the first and second data set using the patches.

The processor may be further arranged for registering the landmarks in the first data set to the landmarks in the second data set using a direct registration method.

According to a further aspect of the invention there is provided software for registering a first data set with a second data set, including:
i) a code portion arranged for storing and retrieving a first and second data set from a memory;
ii) a code portion arranged for receiving input which specifies three or more landmarks in the first data set and three or more corresponding landmarks in the second data set;
iii) a code portion arranged for registering the first data set to the second data set using the landmarks;
iv) a code portion arranged for determining, for at least one of the landmarks, a first patch around the landmark and a second patch around the corresponding landmark; and
v) a code portion arranged for refining the registration between the first and second data set using the patches.

It is preferred that the code portion arranged for registering the landmarks in the first data set to the landmarks in the second data set uses a direct registration method.

### BRIEF DESCRIPTION OF THE DRAWINGS

Embodiments of the invention will now be described, by way of example only, with reference to the accompanying drawings in which:

FIG. 1: shows a diagram illustrating examples of landmarks and patches determined using the method of the invention.

FIG. 2: shows a diagram illustrating how a patch in a subject data set can be registered to a patch in a reference data set.

FIG. 3: shows a screenshot illustrating 3D representations of a subject and reference data set prior to registration.

FIG. 4: shows a screenshot illustrating the selection of landmarks.

FIG. 5: shows a screenshot illustrating the step of registration using the landmarks.

FIG. 6: shows a screenshot illustrating 3D representations of the subject and reference data set after landmark registration.

FIG. 7: shows a screenshot illustrating the refinement step of registration using patches.

FIG. 8: shows a screenshot illustrating 3D representations of the subject and reference data set after patch registration.

### DETAILED DESCRIPTION OF PREFERRED EMBODIMENTS

The present invention relates to a method, software and system for registering a subject data set with a reference data set by using a combination of a landmark registration method followed by a patch registration method to provide a robust and accurate system superior to either one alone.

The present invention will be described in relation to the use of a direct registration method for registering landmarks and an iterative registration method for registering the patches. Direct registration ensures the necessary initial conditions are provided to the iterative method such that the desired minimum is attained.

However, it will be appreciated by those skilled in the art that an iterative registration method may be used for registering the landmarks.

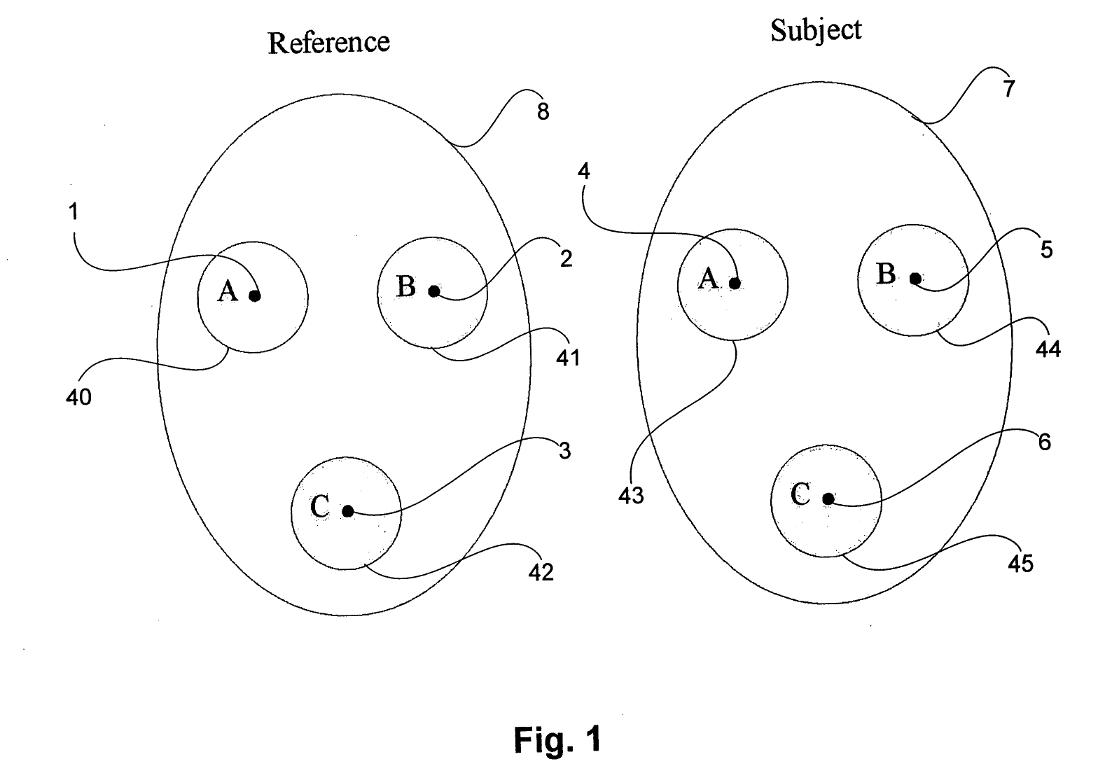

Referring to FIG. 1, a human operator specifies homologous landmarks (1, 2, 3, 4, 5, and 6) in both subject 7 and reference 8 data set.

Alternatively, an automatic method such as feature recognition may be used to choose the landmarks.

A human operator is preferred to reduce the possibility of erroneous registrations. For example, registration may be required to be restricted to regions that are expected to be similar, excluding other regions expected to be different, especially in serial studies before and after some change event.

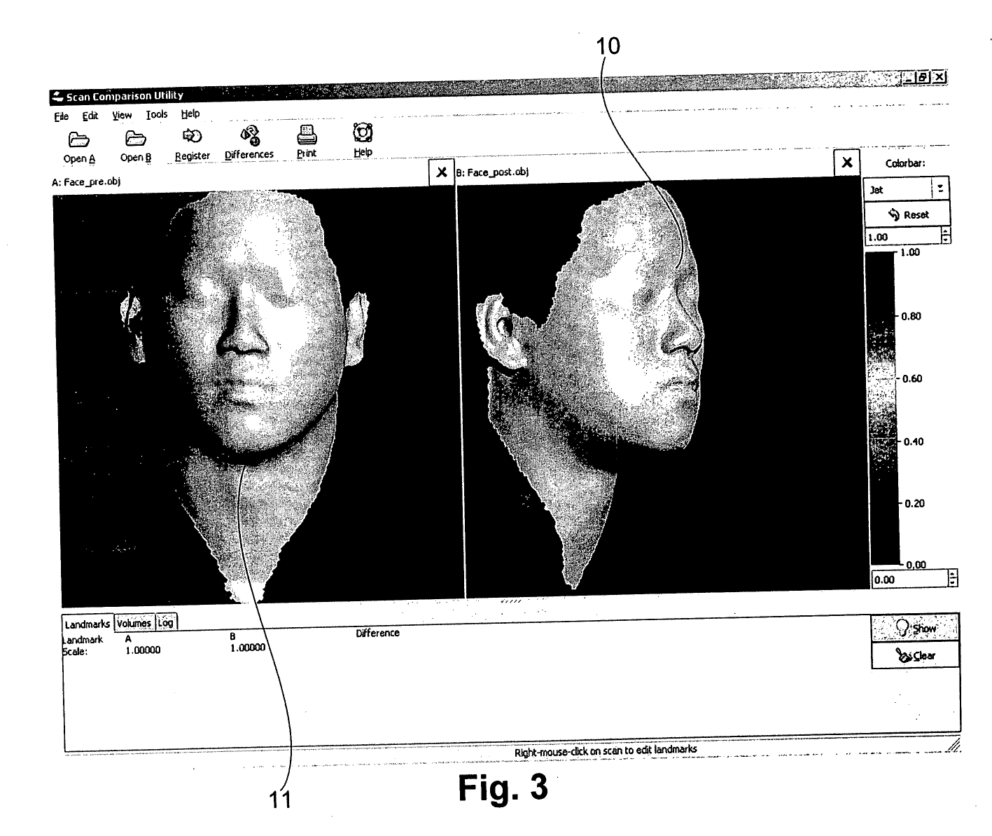

FIG. 3 shows a Graphical User Interface (GUI) for the method of the invention. Within the interface is shown a 3D representation of the subject data set 10 alongside a 3D representation of the reference data set 11.

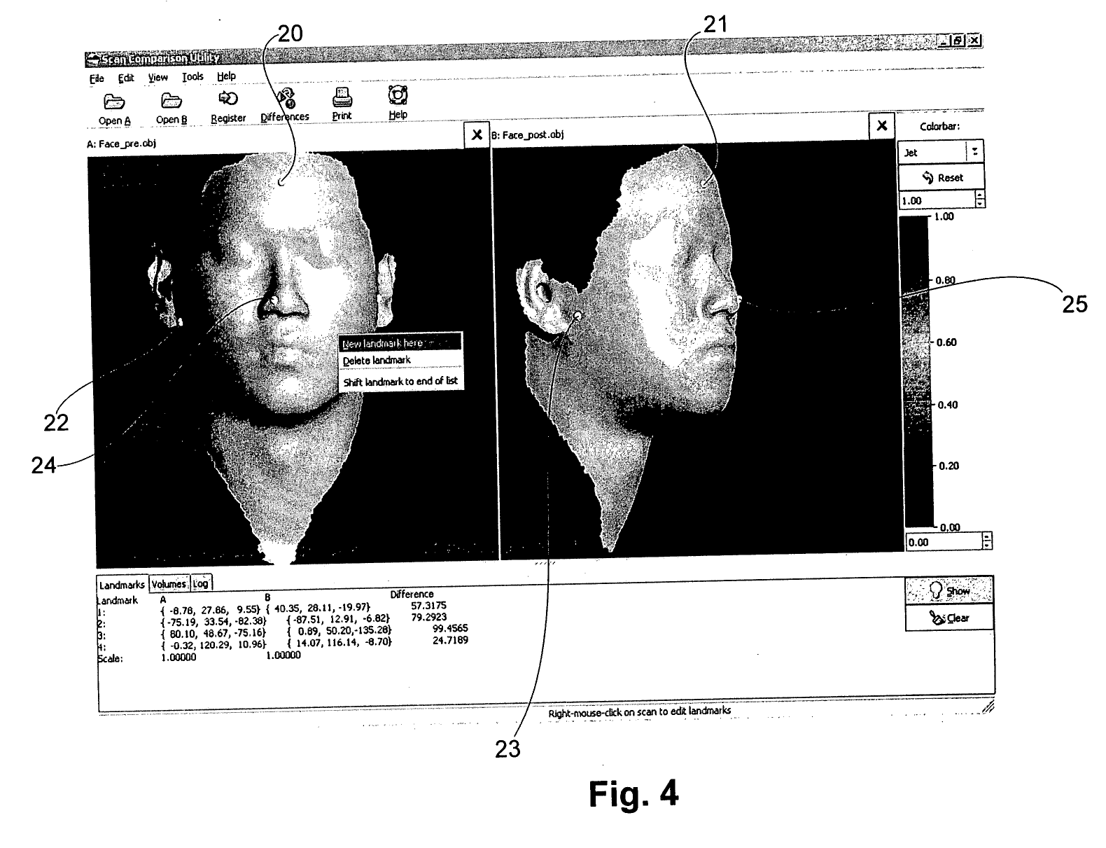

FIG. 4 shows a graphical method of how a user selects landmarks on the 3D models. A landmark 20 is specified by the user on one of the data sets and a corresponding landmark 21 is then specified by the user on the other data set.

At least three homologous landmark pairs (20 and 21, 22 and 23, 24 and 25) are required and must not be coincident or colinear.

Some imprecision may be involved in the relative landmark positions of the subject data set compared to the relative landmark positions of the reference data set, either due to imperfection in the data or a desire to reduce the precision required by the human operator or computer algorithm in the identification process.

In the case of imprecise landmark positions, more than three landmark pairs are to be preferred. The transformation parameters are thus over-determined and less affected by errors in any one landmark location.

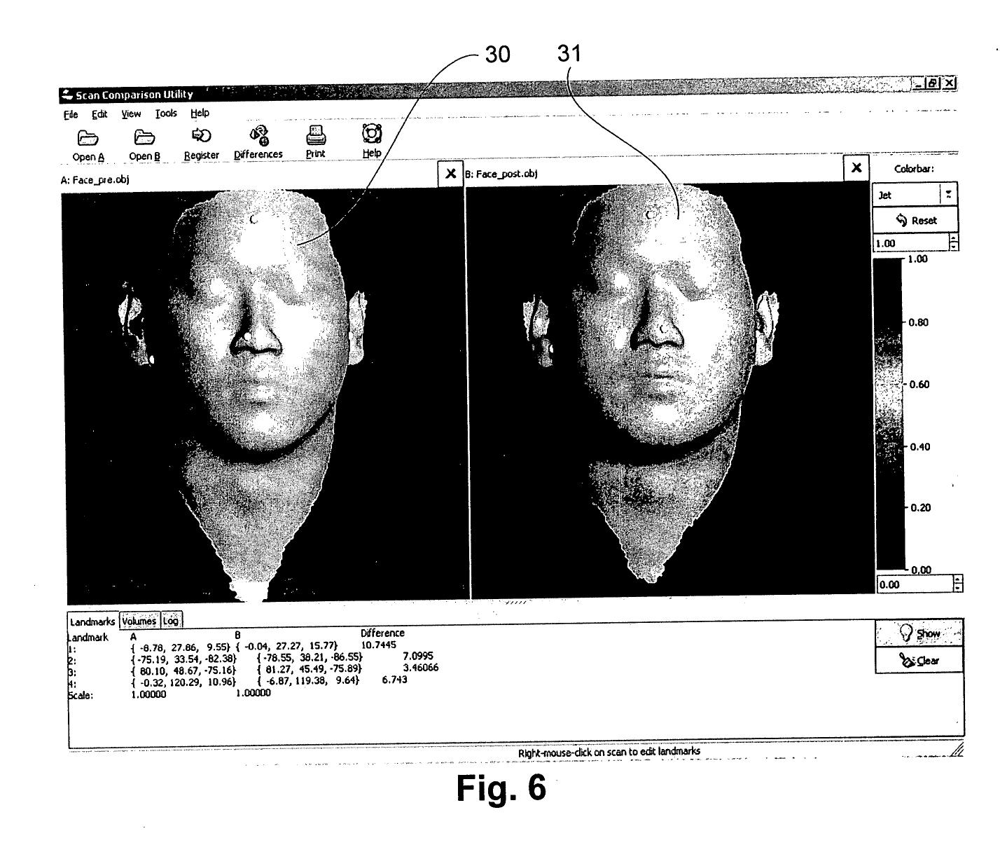

The initial transformation is computed by a direct method. A suitable algorithm for direct rigid body registration of homologous landmarks is singular value decomposition (SVD). This brings both objects 30 and 31 into a similar spatial orientation such as shown in FIG. 6.

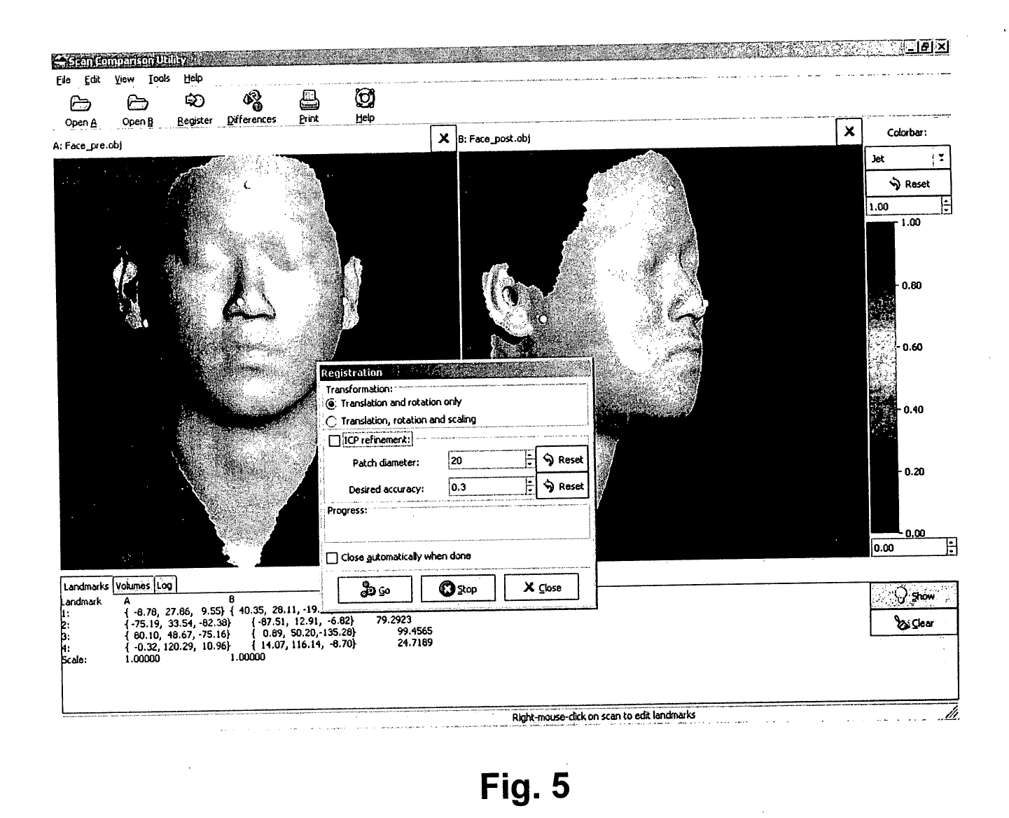

FIG. 5 shows a registration where the user requests the performance of the direct method to register the landmarks selected with their corresponding landmarks.

FIG. 6 shows the result of registering the two data sets using landmarks.

To obtain a refined registration an iterative method using more of the data and starting with the initial transformation from the direct method is used.

The range of the search for an improved registration is restricted by defining a surface region (“patch”) around each landmark. Patches 40, 41, 42, 43, 44, 45, and 46 around landmarks 1, 2, 3, 4, 5, and 6 are shown in FIG. 1.

The boundary of a patch may be specified by the operator at the time of defining the landmark. For example, if the boundary is defined by a sphere, the radius of the sphere about the landmark (the shaded discs in FIG. 1) may be specified. This may be performed graphically on a computer screen.

The same boundary definition can be used for all landmarks.

Patch boundaries around the landmark may also be defined by an arbitrary boundary curve drawn on the surface, or a 2D projection thereof.

Alternatively, the radius may be specified numerically by the operator. The value related to the residual root-mean-square (rms) error in the direct registration process may be presented to the operator as a guide to an appropriate radius value. For example, three times the rms value. This guide should form the lower bound of the radius of the sphere. The rms is calculated as the root-mean-square of the difference between the transformed landmarks of the subject and the landmarks of the reference.

Where the relative landmark positions of the subject data set is precisely the same as the relative landmark positions of the reference data set the rms will be zero and will not provide a helpful value radius value. In such a case a guide value may be given based on the size of the 3D model.

The iterative method is used to minimise the difference between the corresponding patches (i.e. it is a homologous patch registration method).

Iterative closest point (ICP) is an example of an algorithm for iterative registration of surfaces.

For any point in a patch in one data set, the corresponding point in the corresponding patch in the other data set is determined. It may simply be the closest data point, or may be interpolated from the known data points.

These interpolated points on the surface may be interpolated from the measured points using a spline such as a polyharmonic spline. When a polyharmonic spline is used, a biharmonic spline is preferred.

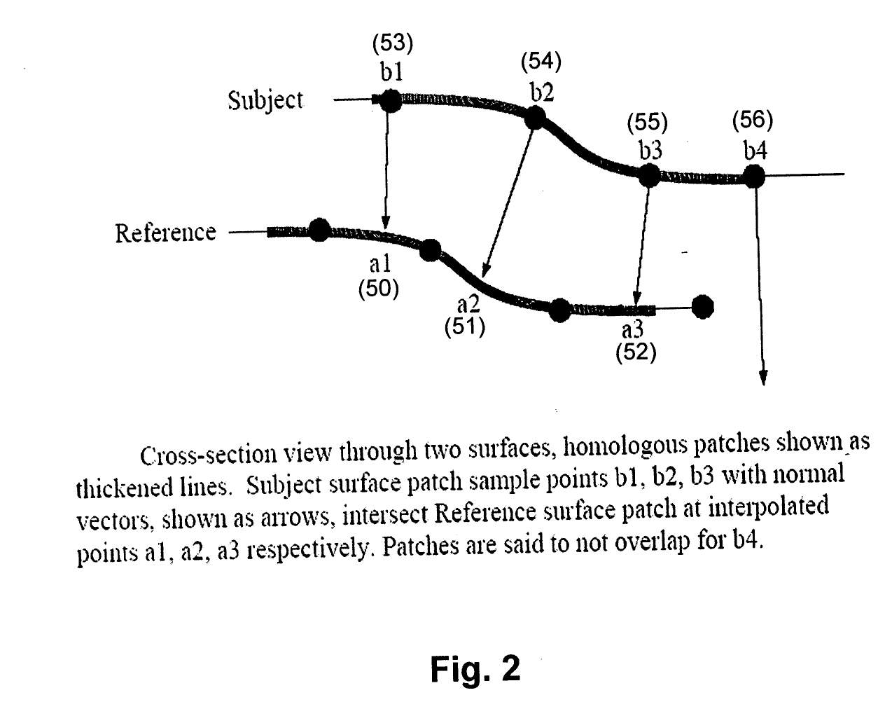

Referring to FIG. 2, additionally the corresponding point a1 (50), a2 (51), and a3 (52) may be required to lie on the vector normal to the surface of the first point b1 (53), b2 (54), and b3 (55). If no such intersection exists then that point b4 (56) can be excluded from the registration, thus allowing for non-overlapping portions of the patches.

Iteration is halted when sufficiently close registration is achieved or no further progress is being achieved.

Suitable other iterative methods as disclosed in An Algorithmic Overview of Surface Registration Techniques for Medical Imaging, Michel A. Audette, Frank P. Ferrie and Terry M. Peters, could be employed.

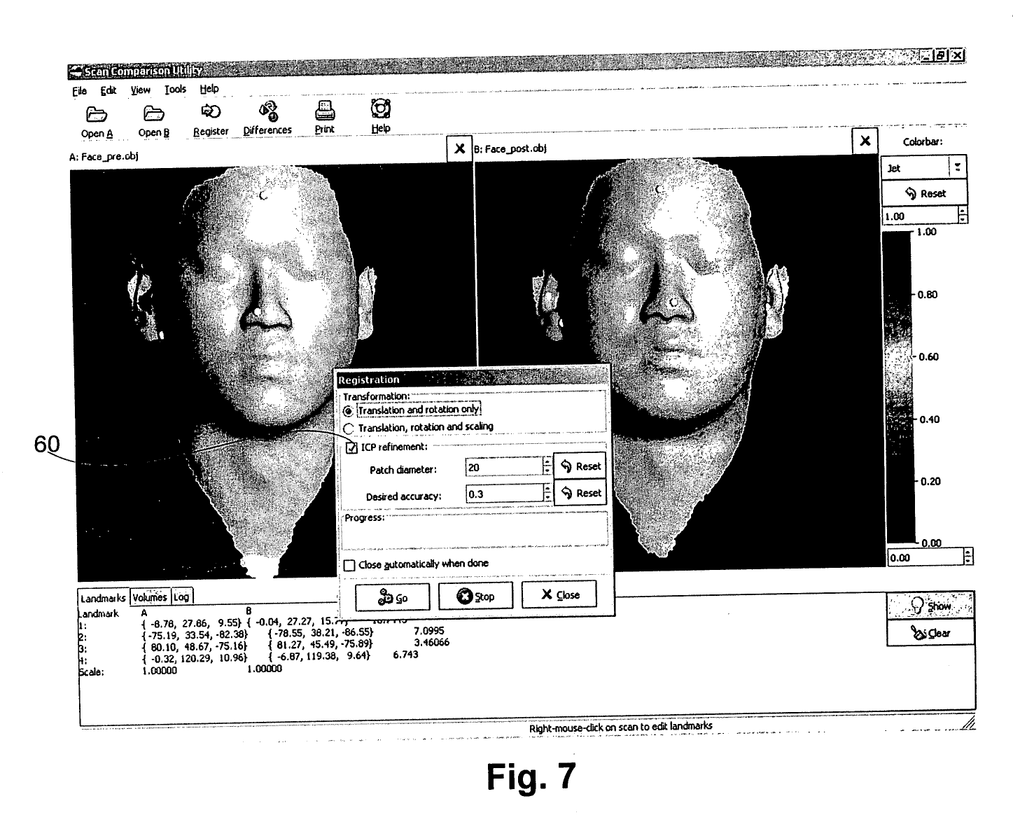

FIG. 7 shows a registration where the user requests 60 the performance of the iterative method to register the patches with their corresponding patches after the landmark registration process has occurred.

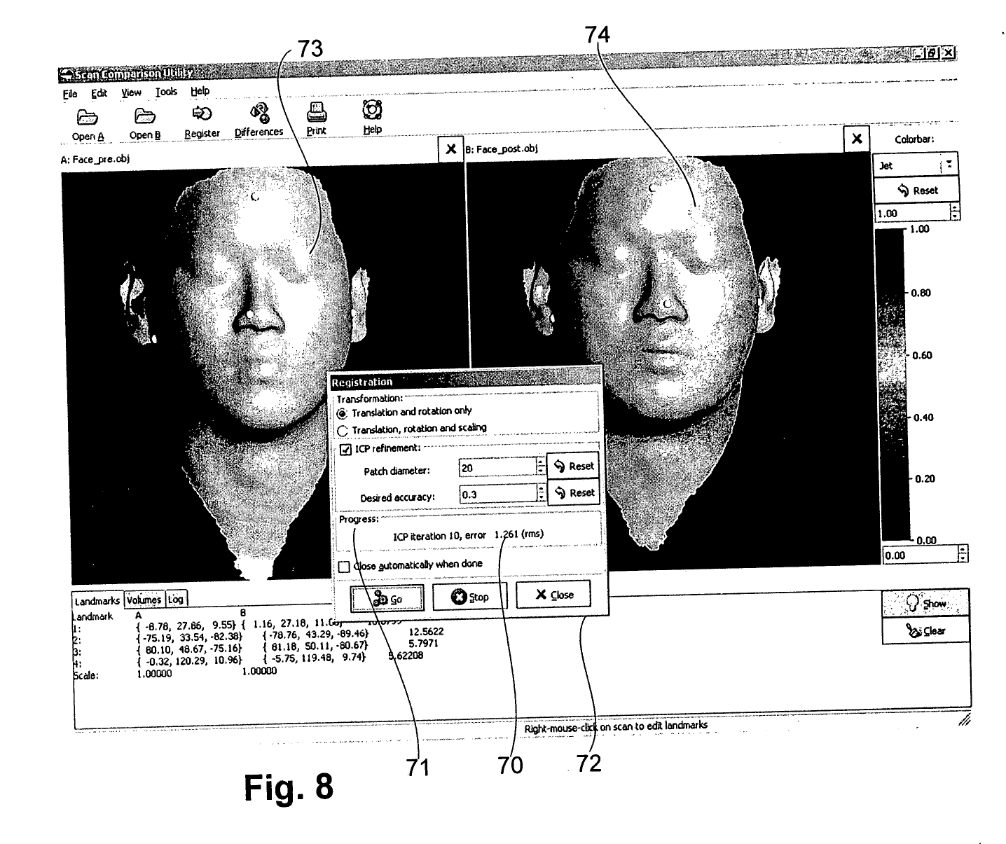

FIG. 8 shows the result of the iterative method. The residual mean square 70 after 10 iterations is shown in the “Progress” portion 71 of the window 72. The two 3D models 73 and 74 have now been registered using the method of the invention.

The method of the invention may be used for the following applications:

1. Two scans of same body part, registered to measure a change in volume, such as:
a) assessing progress and efficacy of a treatment in plagiocephaly
b) measuring volume of swelling in the arm following axilla lymph-node removal
c) surgical audit using serial scans, before and after cranio-maxillo-facial surgery.

2. A scan of a manufactured object and the original design, registered to reveal deviations.

3. Registration of multiple, adjoining and overlapping scans of an object too large to be scanned in a single action.

It will be appreciated that the method of the invention has many more applications than those enumerated above.

The method of the invention can be implemented in software using a programming language such as Visual C++ or Python.

It will be appreciated that other programming languages may be used to implement the method of the invention or that the method be implemented directly in hardware.

The software of the invention can operate on a computer system such as a personal computer or a workstation. The computer system can be using a Windows operating system or a UNIX operating system.

It will be appreciated that the software of the invention may operate on many devices and that the devices could be using one of a variety of operating systems.

The present invention has several advantages including:
Final registration not limited by accuracy of landmark placement. This results in a reduced dependence on user skill and time to specify landmarks.
Patches may be simply defined, e.g. by a single number (one radius, same for all patches). This also results on a reduced dependence on user skill and time to specify patches.
Landmark registration stage ensures patch registration starts near desired solution. Therefore, the iterative stage requires no global search strategy and converges rapidly.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method of registering a first data set with a second data set, including the steps of:
i) specifying three or more landmarks in a first data set;
ii) specifying three or more corresponding landmarks in a second data set;
iii) registering the first data set to the second data set using the landmarks;
iv) for at least one of the landmarks, determining a first patch around the landmark and a second patch around the corresponding landmark; and
v) refining the registration between the first and second data set using the patches.

2. A method as claimed in claim 1 wherein the data sets relate to a 3D model.

3. A method as claimed in claim 2 wherein the data sets relate to a surface 3D model.

4. A method as claimed in claim 3 wherein the registration process in step (iii) is a direct registration method.

5. A method as claimed in claim 4 wherein the refinement process in step (v) utilises an iterative registration method.

6. A method as claimed in claim 5 wherein the landmark is approximately in the centre of the patch.

7. A method as claimed in claim 5 wherein the user specifies each landmark and corresponding landmark.

8. A method as claimed in claim 5 wherein the relative position of the landmarks of the first data set is not precisely the same as the relative position of the landmarks of the second data set.

9. A method as claimed in claim 8 wherein at least one of the patches is a subset of the data contained within a sphere.

10. A method as claimed in claim 9 wherein the radius of the sphere is related to the residual mean error resulting from the registration process in step (iii).

11. A method as claimed in claim 10 wherein the radius of the sphere is specified by the user.

12. A method as claimed in claim 9 wherein the refinement process in step (v) includes matching points in the patch of the first data set with points in the patch of the second data set.

13. A method as claimed in claim 12 wherein the points are interpolated on the surface of the patch of one of the data sets.

14. A method as claimed in claim 13 wherein the surface is interpolated using a spline.

15. A method as claimed in claim 14 wherein the spline is a polyharmonic spline.

16. A method as claimed in claim 15 wherein the polyharmonic spline is a biharmonic spline.

17. A method as claimed in claim 16 wherein the points of one data set are matched with the intersection of the normal vectors of those points with the interpolated surface of the patch of the other data set.

18. A method as claimed in claim 17 wherein the registration process in step (iii) utilises singular value decomposition.

19. A method as claimed in claim 17 wherein the refinement process in step (v) utilises iterative closest point.

20. A method as claimed in claim 17 wherein at least one of the patches is specified by the user.

21. A method as claimed in claim 20 wherein at least one of the patches is specified by the user graphically.

22. A method as claimed in claim 17 wherein at least one of the patches is specified by an arbitrary boundary curve.

23. A method as claimed in claim 22 wherein at least one of the patches is a subset of the data contained within a projection from an arbitrary boundary curve.

24. A method as claimed in claim 17 wherein the refinement process in step (v) includes registration of surface attribute data, such as surface colour.

25. A method as claimed in claim 2 wherein the data sets relate to a volume 3D model

26. A method as claimed in claim 6 wherein the landmarks are specified automatically.

27. A method as claimed in claim 26 wherein the landmarks are specified using automatic feature recognition.

28. A method as claimed in claim 17 wherein the size of all patches is equal.

29. A system for registering a first data set with a second data set, including:
i) a memory for storing a first and a second data set;
ii) an input device arranged for receiving input which specifies three or more landmarks in the first data set and three or more corresponding landmarks in the second data set; and
iii) a processor arranged for registering the first data set to the second data set using the landmarks, then for at least one of the landmarks, determining a first patch around the landmark and a second patch around the corresponding landmark, and then for refining the registration between the first and second data set using the patches.

30. A system as claimed in claim 29, wherein a direct registration method is used to register the first data set to the second data set using landmarks.

31. Software for registering a first data set with a second data set, including:
i) a code portion arranged for storing and retrieving a first and second data set from a memory;
ii) a code portion arranged for receiving input which specifies three or more landmarks in the first data set and three or more corresponding landmarks in the second data set;
iii) a code portion arranged for registering the first data set to the second data set using the landmarks;
iv) a code portion arranged for determining, for at least one of the landmarks, a first patch around the landmark and a second patch around the corresponding landmark; and
v) a code portion arranged for refining the registration between the first and second data set using the patches.

32. Software as claimed in claim 31, wherein a direct registration method is used to register the first data set to the second data using the landmarks.

33. Storage media arranged to store software as claimed in claim 32.

34. A system arranged for performing the method of claim 1.

35. Software arranged for performing the method of claim 1.

36. Storage media arranged to store software as claimed in claim 35.

37. Software arranged for performing the system of claim 29.

38. Storage media arranged to store software as claimed in claim 37.
